(19) United States
(12) Patent Application Publication
(10) Pub. No.: US 2012/0067581 A1
(43) Pub. Date: Mar. 22, 2012

(54) MECHANISM FOR TREATING SUBTERANEAN FORMATIONS WITH EMBEDDED ADDITIVES

(75) Inventors: Francois Auzerais, Boston, MA (US); Huilin Tu, Watertown, MA (US); Sudeep Maheshwari, Cambridge, MA (US); Partha Ganguly, Sugar Land, TX (US); Vadim Khiestkin, Novosibirsk (RU); Bruno Lecerf, Novosibirsk (RU)

(73) Assignee: Schlumberger Technology Corporation, Cambridge, MA (US)

(21) Appl. No.: 12/884,917

(22) Filed: Sep. 17, 2010

(51) Int. Cl. E21B 43/26; C09K 8/42; C09K 8/50

(52) U.S. Cl. 166/308.1; 507/219; 507/225; 507/224

(57) ABSTRACT

The subject disclosure discloses mechanisms for embedding and controlling multifunctional additives within a polymer matrix for use in oilfield applications. More particularly, the subject disclosure discloses methods of treating a subterranean formation with a polymer matrix comprising one or a plurality of polymers and one or a plurality of functional additives embedded into this polymer matrix.

### FIELD OF THE DISCLOSURE

The subject disclosure relates to functional additives for use in oilfield applications for subterranean formations. More particularly, the subject disclosure relates to mechanisms for embedding and controlling multifunctional additives within a polymer matrix.

### BACKGROUND OF THE DISCLOSURE

Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated”, for example using hydraulic fracturing, chemical (usually acid) stimulation, or a combination of the two (called acid fracturing or fracture acidizing).

Hydraulic fracturing of subterranean formations has long been established as an effective means to stimulate the production of hydrocarbon fluids from a wellbore. In hydraulic fracturing, a well stimulation fluid (generally referred to as a fracturing fluid) is injected into and through a wellbore and against the surface of a subterranean formation penetrated by the wellbore at a pressure at least sufficient to create a fracture in the formation. Usually a “pad fluid” is injected first to create the fracture and then a fracturing fluid, often bearing granular propping agents, is injected at a pressure and rate sufficient to extend the fracture from the wellbore deeper into the formation. If a proppant is employed, the goal is generally to create a proppant filled zone from the tip of the fracture back to the wellbore. In any event, the hydraulically induced fracture is more permeable than the formation and it acts as a pathway or conduit for the hydrocarbon fluids in the formation to flow to the wellbore and then to the surface where they are collected.

For years fibers have been used for different purposes in oilfield treatment operations. When fibers are added and mixed to a proppant agent, they are designed to assist in proppant transport and/or to limit proppant flowback after the fracturing operation is complete by forming a porous pack in the fracture zone. Pumped together with the proppant in a fracturing fluid, the fibers form a network that stabilizes the proppant pack. To maintain proppant-pack integrity, the fibers must be sufficiently stable to remain in place during the productive life of the well. Such materials, herein “proppant flowback control,” can be any known in the art, such as those available from Schlumberger under the trade name PropNET®. PropNET® hydraulic fracturing proppant-pack additives, made from glass or polymer fibers, addresses a wide variety of well conditions.

In different applications, such as in cementing in the 1990s, Schlumberger introduced CemNET® advanced fiber cement, which employed glass fibers added to cement slurries to prevent lost circulation. (Low et al., “Designing Fibered Cement Slurries for lost circulation applications: Case Histories,” paper SPE 84617, 2003). As a CemNET® cement slurry flows across a lost circulation zone during primary cementing, the fibers form a bridging network and limit slurry loss from the annulus to the formation.

Fibers also may enhance the proppant transport capabilities of fracturing fluids e.g. FiberFRAC®. Most recently, fiber materials have been used as a fluid diversion service for diverting fracture treatments along a wellbore in cemented or openhole completions e.g. StimMORE®.

In some oilfield applications which use fibers there is a necessity that the fibers be stable in the formation. For other applications, it is desirable that the fibers disappear after the intended function.

Polylactic acid (PLA) fibers have been shown to degrade into soluble materials under temperature and with time. However, all applications are limited to temperatures above 180° F. based on the rate of degradation. At temperatures below 180° F., PLA fibers degrade too slowly to be useful for those oilfield applications. Therefore, it would be useful to have a multifunctional fiber with a broader range of degradation temperatures as well as a higher bridging and plugging efficiency.

### SUMMARY OF THE DISCLOSURE

In view of the above there is a need for an improved mechanism for introducing multifunctional additives downhole. Further, there is a need for an improved mechanism for introducing multifunctional additives downhole such that each function triggered is application specific. In non-limiting examples some of these applications are; promoting degradability, improving bridging and plugging efficiency and/or stabilizing fiber pack. In non-limiting examples some of these functional additives are swellable polymers, crosslinkers and catalysts.

In accordance with an embodiment of the subject disclosure, a method of producing a material for treating a subterranean formation is disclosed. The method comprises combining at least one functional additive with at least one polymer to form a polymer matrix. The method further comprises processing said polymer matrix into an article characterized by a particular shape.

In accordance with a further embodiment of the subject disclosure, a composition for use in treating a subterranean formation is disclosed. The composition comprises at least one functional additive with at least one polymer to form a polymer matrix. The polymer matrix is processed into an article characterized by a particular shape.

In accordance with a further embodiment of the subject disclosure, a method of treating a subterranean formation is disclosed. The method comprises one or a plurality of polymers. The method further comprises compounding one or a plurality of additives into the one or a plurality of polymers forming a polymer matrix. The method further comprises processing said polymer matrix into an article having one or more shapes and introducing said polymer matrix into a wellbore.

Further features and advantages of the subject disclosure will become more readily apparent from the following detailed description when taken in conjunction with the accompanying drawings.

### BRIEF DESCRIPTION OF THE FIGURES

FIG. 1 shows different fiber shapes which may be used with embodiments of the subject disclosure;

FIG. 2 is a graph plotting radius change of polylactic acid (PLA) fiber compound rods as a function of degradation time;

FIG. 3 is a graph plotting the effect of different additive concentration on the degradation of polylactic acid (PLA) fiber compound rods; and

FIG. 4 is a graph plotting the effect of an embedded swellable additive, polyacrylic acid (PAA) on the degradation of polylactic acid (PLA) fiber compounds.

### DETAILED DESCRIPTION

At the outset, it should be noted that in the development of any such actual embodiment, numerous implementation-specific decisions must be made to achieve the developer's specific goals, such as compliance with system related and business related constraints, which will vary from implementation to another. Moreover, it will be appreciated that such a development effort might be complex and time consuming but would nevertheless be a routine undertaking for those of ordinary skill in the art having the benefit of this disclosure. The description and examples are presented solely for the purpose of illustrating the preferred embodiments of the subject disclosure and should not be construed as a limitation to the scope and applicability of the subject disclosure. While the compositions of the subject disclosure are described herein as comprising certain materials, it should be understood that the composition could optionally comprise two or more chemically different materials. In addition, the composition can also comprise some components other than the ones already cited.

Embodiments of the subject disclosure include embedding all necessary functionalities for an application on a multi-component or multifunctional polymer matrix. In comparison to traditional methods of adding bulk additives to fracturing fluids, where each additive is premixed in a pad or placed at a different stage, the disclosed embodiments are very efficient as the functional agents e.g. degradation catalyst are embedded within the polymer matrix. Embedding the functional agents within the polymer matrix eliminates segregation or heterogeneity in the reaction. Embodiments of the subject disclosure minimize operating procedures to fewer steps while providing a higher level of service quality utilizing the same equipment. Also, from a logistical point of view, embodiments of the subject disclosure minimize the number of transported bulk additives at the wellsite since all the chemical agents needed for the operation are embedded in the polymer matrix for example, a fiber. Multifuctional fibers may be used in situations where it is necessary to temporarily block fractures, divert fluid flow and induce the creation of additional fractures along the wellbore for any operational temperature and pressure range.

Conventional fracturing fluids for example, StimMORE® slurry which uses slickwater for gas shale, proppants with the addition of degradable fibers such as PLA (Polylactic acid) fibers and additives such as calcium hydroxide. A difficulty, related to conventional fracturing fluid is the placement of the fibers and the additives together. For optimum performance, the PLA and bulk additives need to be pumped and placed next to each other. In certain situations, it may be difficult to localize the PLA and bulk additives together, while pumping on the fly, due to the intrinsic differences in physical and chemical properties of the PLA and bulk additives.

To simplify the operations of conventional fracturing fluids, embodiments of the subject disclosure provide for incorporating functional agents into suitable polymer matrices. Further, the subject disclosure provides for utilizing conventional methods of polymer compounding and processing e.g. fiber spinning to produce the materials. Polymer compounding is a mixing (dispersion and distribution) process by which a formulation of polymers and other ingredients is converted to an integrated material with targeted properties. The materials may be produced in any suitable geometric shape or size. Further, the materials may be produced with varying physical properties e.g. density. Finally, the materials may be produced with varying chemical attributes e.g. composition, single/or multi-core and variable spatial distribution of chemicals in the fibers. Polymer compounds may be custom designed for different applications. For example, polymer compounds may be custom designed for multi-zone diversion in gas shale or for mitigation of lost circulation while drilling and/or cementing.

One embodiment of a polymer matrix, suitable for multi-zone diversion in gas shale comprises the following, a degradable polymer, for example, PLA and one or a plurality of additives, for example inorganic bases. An example of a suitable inorganic base is calcium hydroxide which provides a catalyst for a degradation reaction. Federov et al, disclose in a related Schlumberger patent application entitled “Method for treating subterranean formation with degradable material at low temperature”, Serial No.: PCT/RU2009/000477, filed Sep. 16, 2009, the contents of which are hereby incorporated by reference, a number of other caustic materials such as CaO, Ca(OH)₂, MgO as well as liquid additives such as NaOH and KOH. Federov et al. further disclose a number of oxidizing agents such as (NH₄)₂S₂O₈ and CaO₂ which increase the rate of PLA degradation when used in conjunction with metal oxides.

In one aspect, embodiments disclosed herein relate to treatments used in oilfield operations. More particularly, embodiments disclosed herein related to treatments used for multi zone diversion in gas shale, mitigation of lost circulation while drilling and/or cementing and finally embodiments disclosed herein relate to treatments which are capable of transformation in situ at certain downhole conditions. Embodiments of the present disclosure include a polymer matrix and one or a plurality of functional additives.

The polymer matrix in non-limiting examples may comprise a degradable polymer. Degradable material may include polyesters from biological and mineral origins including aliphatic and aromatic esters. Degradable materials may include materials, such as fibers. For example, such degradable fibers may be formed from poly(lactic acid) or PLA (polylactide) which may include PLLA (poly-L-lactide), PDLA (poly-D-lactide) or PDLLA (poly-DL-lactide), PGA (polyglycolic acid), PLGA (poly(lactic-co-glycolic acid), polybutylene succinate, PHA (polycaprolactone polyhydroxyalcanoate), polybutylene succinate terephthalate, or mixtures thereof.

The degradable polymer may comprise polysaccharides including starch, cellulose, lignin, chitin and their derivatives. The degradable polymer may comprise proteins including gelatin, casein, wheat gluten, silk or wool. The degradable polymer may comprise lipids including plant oils which may include castor oil and animal fat. Finally, the degradable polymer may comprise PVA (polyvinyl alcohol) or miscellaneous polyolefins e.g. natural rubber, modified polyethylene and polypropylene possibly with specific agents sensitive to temperature, pH, salt and other specific chemicals and blends.

According to some embodiments, degradable material is a degradable fiber or degradable particle. For example, degradable fibers or particles made of degradable polymers are used. The differing molecular structures of the degradable materials that are suitable for the present embodiments give a wide range of possibilities regarding regulating the degradation rate of the degradable material. The degradability of a polymer depends at least in part on its backbone structure. One of the more common structural characteristics is the presence of hydrolysable and/or oxidizable linkages in the backbone. The rates of degradation of, for example, polyesters, are dependent on the type of repeat unit, composition, sequence, length, molecular geometry, molecular weight, morphology (e.g., crystallinity, size of spherulites, and orientation), hydrophilicity, surface area, and additives. Also the environment to which the polymer is subjected may affect how the polymer degrades, e.g., temperature, presence of moisture, oxygen, microorganisms, enzymes, pH, and the like. One of ordinary skill in the art, with the benefit of this disclosure, will be able to determine what the optimum polymer would be for a given application considering the characteristics of the polymer utilized and the environment to which it will be subjected.

According to some embodiments, the polymer matrix or a portion of the polymer matrix may comprise a swellable polymer. The swellable polymer may comprise PAA (polyacrylic acid), PMA (polymethyacrylic acid), PAM (polyacrylamide), PAA-co-PAM (poly(acrylic acid-co-acrylamide), PEO (polyethylene oxide), PEG (polyethylene glycol), PPO (polypropylene oxide) and other swellable polymers as known to those skilled in the art.

According to some embodiments, the polymer matrix or a portion of the polymer matrix may comprise non-degradable and non-swellable polymers. This non-degradable and non-swellable polymer may be mixed with the degradable and/or swellable polymers to yield a certain desired set of properties, such as in non-limiting examples, mechanical properties or processability.

According to some embodiments, the polymer matrix may comprise homopolymers, copolymers or blends of the above listed polymers. According to some embodiments, different polymer architectures are suitable including linear, branched, grafted, cyclic or lightly crosslinked. According to some embodiments, polymer length may play a role in the polymer degradation rate. Shorter polymers tend to degrade faster due to the higher concentration of chain ends. In addition, the polydispersity index (PDI) of polymer molecular length plays a role. A polydisperse polymer material tends to degrade faster than a monodisperse polymer material with the same average polymer length. Further, in some embodiments polymers with a broad range of molecular weight from about 1000-10,000,000 are suitable for the polymer matrix.

According to some embodiments, the functional additives include catalysts for degradation reactions. In some embodiments, water is a reagent for the degradation and hydrolysis occurs. Both acids and bases are suitable as the degradation catalyst but in most cases bases are more effective. In some embodiments, common bases for catalyzing the polyester degradation include calcium hydroxide, calcium oxide, magnesium hydroxide, magnesium oxide, zinc oxide, DMAP (4-dimethylaminopyridin) and DBU (1,8-Diazabicyclo[5.4.0]undec-7-ene), combinations of amines with K₂CO₃(potassium carbonate) and others as known to those skilled in the art. Polyester degradation is a reversible reaction. Catalysts which catalyze the ester formation are also good catalysts for the reverse reaction of esterfication, i.e. hydrolysis. In some embodiments, these include metal ions, cyclodextrins, enzymes and nucleophiles. In some embodiments, common examples include tin chloride, organic tin compounds and organic titanium compounds. Further examples may be obtained in “March's Advanced Organic Chemistry”, 5th Ed.: Smith, M. B. and March, J., John Wiley & Sons, New York: 2001.

According to some embodiments, the functional additives include crosslinkers for in situ modifying materials by crosslinking reactions. In some embodiments, these crosslinkers and crosslinking co-agents include sulfur, sulfur containing crosslinking agents, TAIC (Triallyl Isocyanurate), TAC (Triallyl Cyanurate), borates, zirconium salts, zinc salts, calcium salts and others as known to those skilled in the art.

According to some embodiments, the functional additives include initiators for initiating degradation or polymerization. In some embodiments, peroxides such as APS (ammonium persulfate), potassium persulfate and others as known to those skilled in the art are useful for initiating degradation or polymerization reactions.

According to some embodiments, other additives which may be used in certain applications include fillers. In some embodiments, fillers such as carbon black, silica, clay and their organically modified derivatives may be used. In some embodiments, plasticizers may be used in certain applications. In some embodiments, these plasticizers are small organic molecules derived from oligomers of the polymers identified above, for example, degradable polymers, swellable polymers and their copolymers and blends. Finally, in some embodiments, processing aids may be used, for example, fatty acids.

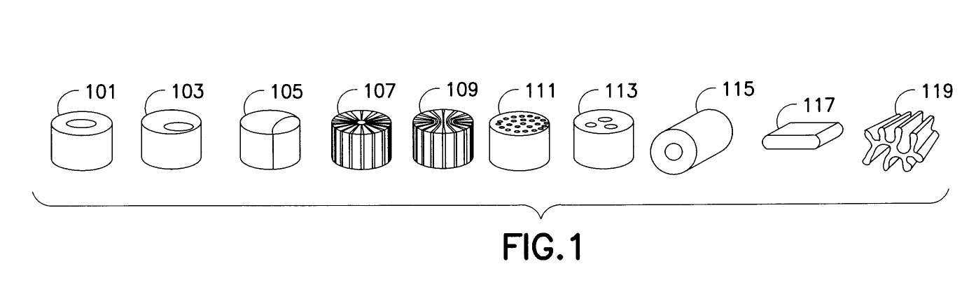

Embodiments of the present technology are generally in the form of a fiber, rod, pellet or disc, although other article shapes are contemplated and may be formed. Article shapes which are suitable are those that provide expandable surface area control to efficiently transport functionalities onto the shape of a fiber to ensure that an optimum amount of a critical reagent is present for the intended reaction. The fiber in one non-limiting example may contain 0.1 to 99% by weight of the chosen functional agents. In other non-limiting examples the fiber may contain 0.5-20% by weight of the chosen functional agents. Fiber shapes which may be used include core shell, multi core, hollow and splittable, although other available fiber shapes generated as a result of extrusion and fiber spinning are contemplated and may be formed. FIG. 1 show examples of fiber shapes which may be used with embodiments of the subject disclosure. Some of these shapes are bicomponent fibers which are fibers that are “co-extruded” with two different polymers in the cross section. The advantage of this arrangement is that it allows the fiber to use the properties of both materials which expands the array of possible fiber performance characteristics. Referring to FIG. 1 the following bicomponent fiber shapes may be used for embodiments of the present disclosure, concentric sheath/core (101), eccentric sheath/core (103), side-by-side (105), pie wedge (107), hollow pie wedge (109), islands/sea (111), three islands (113). Shapes with a modified cross section which may offer added functionality e.g. moisture transport may also be used for embodiments of the subject disclosure. FIG. 1 shows a number of examples of these shapes with a modified cross section. In non-limiting examples they include a hollow shape (115), a ribbon shape (117) and a trilopal shape (119). As discussed, a broad range of article shapes may be used for embodiments of the subject disclosure and by carefully controlling the constituent materials, extrusion die and processing techniques these shapes may be used for different applications.

Embodiments of the present disclosure may be manufactured or formed by commonly used methods utilizing a broad range of conventional manufacturing techniques for example, melt extrusion, solution extrusion, and fiber spinning both filament and staple which are all suitable for producing embodiments of the present disclosure which in non limiting examples comprise a functional polymer compound having a specific shape as discussed above.

Embodiments of the present disclosure may be used in a variety of oilfield applications including fluid loss control, temporary sealing in downhole applications, fracturing including proppant transport, proppant flow back control, fluid diversion for multi zone fracturing and high conductivity flow channel creation, acidizing, cementing, completion or water control, or any combinations thereof.

Embodiments of the present disclosure may also be used in multi-stage fracturing in gas shale. The polymer matrix of the subject disclosure may enable on demand multi-stage fracturing where it may be necessary to temporarily block fractures, divert fluid flow and induce the creation of additional fractures along a wellbore in varying operational temperature and pressure ranges. Upon exposure to specific downhole fluids including fracturing fluids controlled degradation may occur.

### EXAMPLES

The present embodiments can be further understood from the following examples:

### Example 1

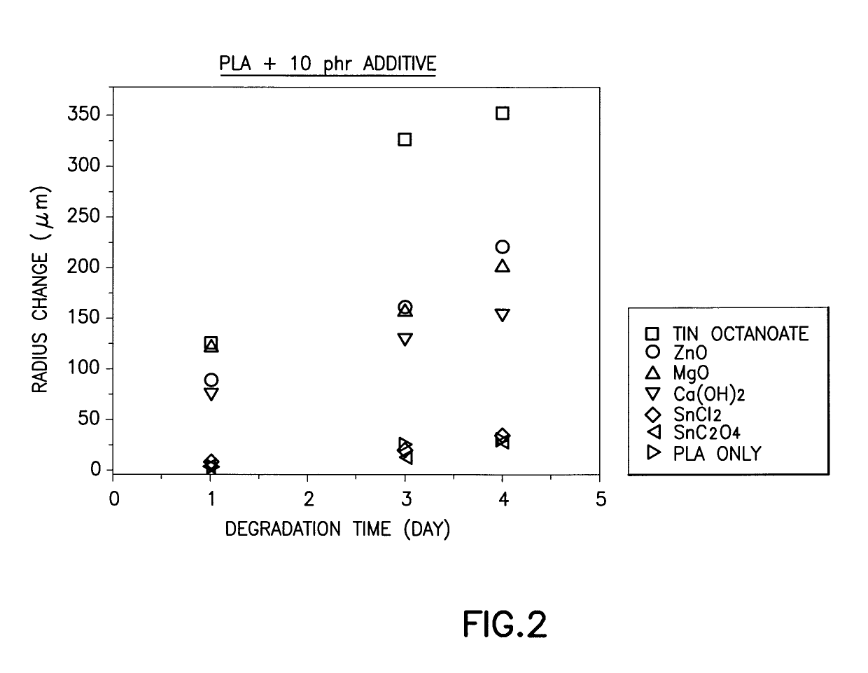

FIG. 2 depicts the radius change of polylactic acid (PLA) compound rods as a function of degradation time. A series of PLA compounds were prepared with 10 phr (parts per hundred resin) of an embedded additive. These embedded additives serve as catalysts for the PLA degradation reaction. The additives used include tin octanoate, zinc oxide (ZnO), magnesium oxide (MgO), calcium hydroxide (Ca(OH)₂, tin chloride (SnCl₂) and tin oxalate (SnC₂O₄). The samples were compounded and extruded using a twin-screw extruder. Twin screw extrusion is used extensively for mixing, compounding, or reacting polymeric materials. The flexibility of twin screw extrusion equipment allows the operation to be designed specifically for the formulation being processed. For example, the two screws may be corotating or counterrotating, intermeshing or nonintermeshing. In addition, the configurations of the screws themselves may be varied using forward conveying elements, reverse conveying elements, kneading blocks, and other designs in order to achieve particular mixing characteristics. A pure PLA sample was used as a control. The resulting extruded PLA compound rods have a typical thickness of approximately 0.5-0.9 mm. The thickness and weight of the rods were measured before degradation began. The samples were then submerged in de-ionized water at approximately 82° C. for a pre-defined time period. The water to PLA compound weight ratio was approximately 100.0:1.2. The samples were then dried for approximately 3 hours in a drying oven at approximately 82° C. The degraded PLA compound samples were weighed after drying was complete. FIG. 2 shows that results for tin octanoate, zinc oxide (ZnO), magnesium oxide (MgO), and calcium hydroxide (Ca(OH)₂ significantly enhance the degradability of the PLA material. FIG. 2 further shows that both tin chloride (SnCl₂) and tin oxalate (SnC₂O₄) have a marginal or no catalyzing effect on PLA degradation. As can be seen, a broad range of degradation rates can be achieved by utilizing different additives. Accordingly, from these experimental data it can be concluded that using different additives results in a broad range of degradation rates.

### Example 2

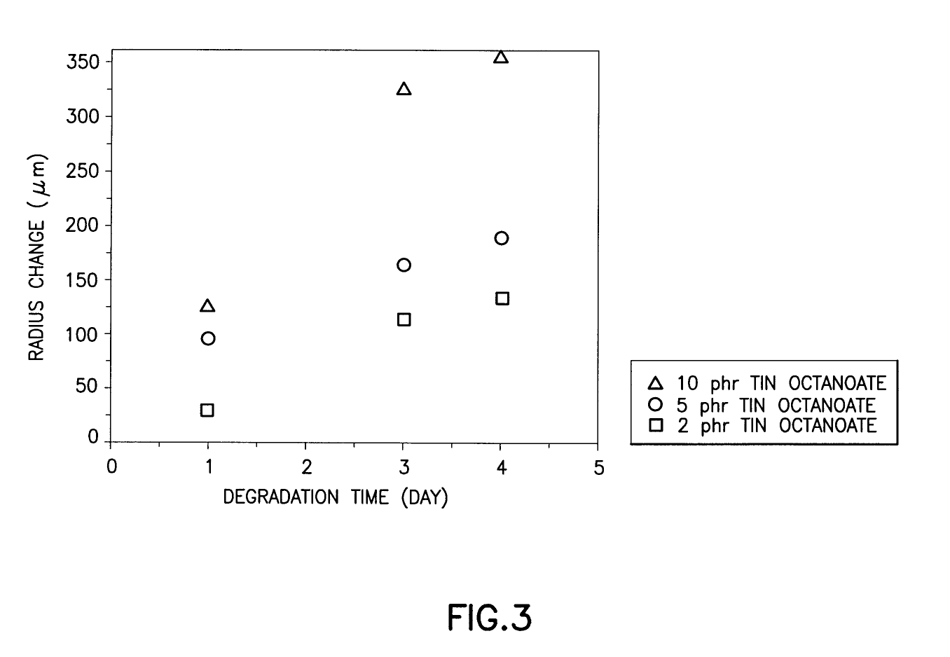

FIG. 3 shows the results of the effect of different additive concentrations on the degradation of PLA. Experiments were carried out to examine the effect of different additive concentrations in the polymer compound on the degradation of PLA compounds. The concentration of tin octanoate, zinc oxide (ZnO), magnesium oxide (MgO), and calcium hydroxide (Ca(OH)₂ was varied in the PLA compounds. Degradation experiments were then carried out. Enhanced degradability was consistently observed, as the concentration was increased for each of the additives in the PLA matrix. As an example, FIG. 3 presents the data of PLA and tin octanoate compounds with three different concentrations: 2 phr, 5 phr and 10 phr. Similar to example 1 above, PLA degradation was characterized by a radius change of the PLA compound rods as a function of degradation time. Further, the water to PLA compound weight ratio was approximately 100.0:1.2. Accordingly, from these experimental data it can be concluded that the concentration of additives may be used as a tuning parameter to achieve a desired degradation rate for each different application of embodiments of the subject disclosure. Further, PLA degradation may be effectively controlled using a selected additive for the application in question.

### Example 3

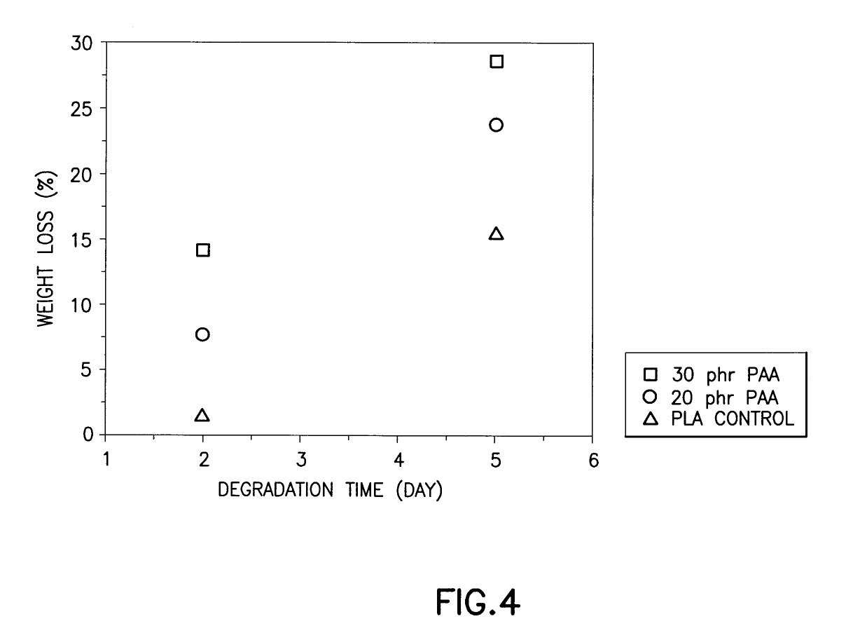

FIG. 4 shows the results of embedding a swellable additive polyacrylic acid (PAA) on the degradation of PLA compounds. Swellable polymers and in one non-limiting example, polyacrylic acid (PAA) can be added to the PLA matrix to tune the degradability of the PLA compounds. Similar to example 1, the degradation temperature is approximately 82° C. (180° F.), the degradation medium is de-ionized water and the water to PLA compound weight ratio is approximately 100.0:1.2. In this example, the samples used were thin films with a thickness of approximately 0.1-0.2 mm. The addition of PAA to PLA enhanced the degradation of the PLA compound and by increasing the concentration of PAA the rate of degradation of the PLA compound increased. It is possible that the PAA additive increases both the absorption rate and the equilibrium absorption rate of water. The degradation rate of the PLA compound would therefore increase as a result of faster water uptake and higher water concentration. Further, the swellable polymer may swell, thus degrading the mechanical properties of the materials, therefore, enhancing the degradability of the PLA compounds. In certain applications, complete degradation of the polymer matrix is not necessary and fragmentation of the compounds by mechanical stress due to sufficient differential pressure may be sufficient. For example, in certain applications where the polymer matrix is used as a plug or a diverter for fluid flow, fragmentation of the compounds by mechanical stress may be sufficient to destroy the plug or the diverter and fluid flow resumes.

While the subject disclosure is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A method of producing a material for treating a subterranean formation, comprising:
combining at least one functional additive with at least one polymer to form a polymer matrix; and
processing said polymer matrix into an article characterized by a particular shape.

2. The method of claim 1 wherein said processing is by extruding, molding and/or fiber spinning said polymer matrix to produce said particular shape.

3. The method of claim 1 wherein the at least one polymer is a degradable polymer.

4. The method of claim 3 wherein the at least one functional additive delays degradation of the degradable polymer.

5. The method of claim 3 wherein the at least one functional additive accelerates degradation of the degradable polymer.

6. The method of claim 3 wherein the degradable polymer comprises a water-degradable polymer.

7. The method of claim 6 wherein the water-degradable polymer comprises a polyester.

8. The method of claim 7 wherein the polyester comprises a polylactide.

9. The method of claim 8 wherein the polylactide comprises one or more of PLLA (poly-L-lactide), PDLA (poly-D-lactide) or PDLLA (poly-DL-lactide), PGA (polyglycolic acid), PLGA (poly(lactic-co-glycolic acid), polybutylene succinate, PHA (polyhydroxyalkanoate), poly(ε-caprolactone), polyethylene terephthalate, or derivatives thereof.

10. The method of claim 1 wherein the at least one polymer is a swellable polymer.

11. The method of claim 10 wherein the swellable polymer comprises one or more PAA (polyacrylic acid) or PMA (polymethyacrylic acid) or PAM (polyacrylamide) or PAA-co-PAM (poly(acrylic acid-co-acrylamide) or PEO (polyethylene oxide) or PEG (polyethylene glycol) or PPO (polypropylene oxide), or derivatives thereof.

12. The method of claim 1 wherein the polymer matrix comprises at least one of a degradable polymer, a non-degradable polymer, a swellable polymer, a non-swelling polymer, or mixtures thereof.

13. The method of claim 1 wherein the polymer matrix comprises copolymers, homopolymers, and blends thereof.

14. The method of claim 1 wherein a polymer structure of the at least one polymer is a linear, branched, grafted, cyclic or crosslinked polymer structure, or combinations thereof.

15. The method of claim 1 wherein a weight average molecular weight of the at least one polymer is in the range of 1000-10,000,000.

16. The method of claim 1 further comprising one or a plurality of different functional additives.

17. The method of claim 16 further comprising increasing or decreasing a concentration of the one or a plurality of different functional additives.

18. The method of claim 1 wherein the at least one functional additive is a degradation catalyst, a crosslinker, a degradation initiator and/or a polymerization initiator, or combinations thereof.

19. The method of claim 1 wherein an additive weight ratio is within a range of 0.1-99%.

20. The method of claim 1 wherein an additive weight ratio is within a range of 0.5-20%.

21. The method of claim 1 wherein a particular shape is selected from the group consisting of fibers, rods, pellets or disc.

22. The method of claim 1, wherein the treatment comprises fluid loss control, diversion, cementing, completion, or water control, or any combination thereof.

23. A composition for use in treating a subterranean formation, comprising:
at least one functional additive with at least one polymer to form a polymer matrix; and
said polymer matrix processed into an article characterized by a particular shape.

24. The composition of claim 23 wherein the at least one polymer is a degradable polymer.

25. The composition of claim 23 wherein the particular shape is a fiber.

26. The composition of claim 24 further comprising one or a plurality of different functional additives wherein a degradation rate of the degradable polymer is manipulated by using the one or a plurality of different functional additives.

27. The composition of claim 26 wherein the one or a plurality of different functional additives increase or decrease the degradation rate of the degradable polymer.

28. The composition of claim 24 having improved degradability by increasing a concentration of the at least one functional additive.

29. The composition of claim 23 used for treating lost circulation.

30. A method of well treatment, comprising:
injecting a slurry comprising the composition of claim 23;
allowing the article to form a plug in one or more than one of a perforation, a fracture, and a wellbore in a well penetrating a formation; and
performing a downhole operation; and
allowing the article to at least partially degrade after a selected duration such that the plug disappears.

31. The method of claim 30 wherein the method of well treatment comprises hydraulic fracturing.

32. A method of treating a subterranean formation, comprising:
providing one or a plurality of polymers;
compounding one or a plurality of additives into the one or a plurality of polymers and forming a polymer matrix;
processing said polymer matrix into an article having one or more shapes; and
introducing said polymer matrix into a wellbore.

33. A method of producing a material for treating a subterranean formation, comprising:
combining at least one functional additive with at least one polymer to form a polymer matrix;
varying a concentration of the at least one functional additive; and
processing said polymer matrix into an article characterized by a particular shape.
